(19) United States
(12) Patent Application Publication
(10) Pub. No.: US 2016/0346904 A1
(43) Pub. Date: Dec. 1, 2016

(54) MAGNETIC TABLE

(71) Applicant: Thomas Marshall, Lakeshore, UT (US)

(72) Inventor: Thomas Marshall, Lakeshore, UT (US)

(21) Appl. No.: 15/097,160

(22) Filed: Apr. 12, 2016

Related U.S. Application Data
(60) Provisional application No. 62/146,710, filed on Apr. 13, 2015.

(51) Int. Cl. B25B 11/00; B24B 41/06; B23K 37/04; B23Q 3/154

(52) U.S. Cl. CPC B25B 11/002; B23Q 3/1546; B24B 41/06; B23K 37/04

(57) ABSTRACT

A magnetic table for holding parts to be welded, ground, buffed, or smoothed. A magnetic frame securely holds metallic parts of a wide range of sizes and types in the desired orientation for delicate work. The magnetic frame can be affixed to a standard metal work surface, and can be lifted open to easily remove the finished part, as well as most dust and debris.

### BACKGROUND

1. State of the Art

The present invention relates to systems for holding parts that must be welded, ground, buffed, or polished. More specifically, the present invention relates to a magnetic table capable of securely holding metallic parts of a wide range of sizes and types in the desired orientation for delicate work. The magnetic table can be affixed to a standard metal work surface to securely hold parts being worked on, while being easy to clear of dust, debris and even parts when desired.

2. Field of Art

A wide variety of materials can be used to make parts for other mechanisms. However when such engine, mechanical, metal art, blades, or other metal parts are produced, they frequently contain burrs, rough edges, or uneven surfaces. These defects can cause a part to malfunction, raise the risk of user injury, and may not look appealing. To improve the function and look of a metal part, parts of its surface must be smoothed or polished. This is most frequently accomplished by grinding, lapping, or sanding.

Grinding can produce very fine finishes and very accurate dimensions, often down to the micrometer or smaller. The technique can also rough out large volumes of metal quite rapidly. Specialized grinding techniques such as lapping—rubbing two surfaces together with an abrasive between them—and sanding can result in even finer surface characteristics. Any of these techniques may be performed either in a dry or wet environment.

Grinding, however, can produce large quantities of dust and fragments. Dust which is fine enough to inhale must be filtered from the air, or prevented from escaping into the air in the first place.

In addition, a wide variety of tools are used to grind metal parts, such as hand-cranked sharpening stones, handheld grindstones, bench grinders, handheld power tools such as angle grinders and die grinders, bench grinders, creep-feed grinders, cylindrical grinders, rotating abrasive wheels, and computerized industrial grinders. These tools are commonly used with either a static or reciprocating work table, or a work clamp. A reciprocating worktable allows a user to pass the part to be smoothed under the grinding head or wheel multiple times, with each pass resulting in a smoother finish. In centerless grinding, the part is typically clamped onto a work rest, such as a post, while the grinding heads are angled at desired locations around the part.

In such an environment, holding the part to be ground, polished, etc., can be very difficult. Clamps can interfere with the grinding process and take time to secure and release. Moreover, clamping results in a portion of the part being inaccessible. In order to change the orientation of the part, it must be unscrewed or unclamped, rotated, and then screwed or clamped in place again. It is difficult to switch back and forth between orientations. Additionally, when a very small part is being ground, most of its area may be covered by the clamp, chuck, or jig pads. Thus, in order to smooth an entire piece, a user may be forced to change its orientation a dozen times or more to expose each surface to the grinder head.

Moreover, attachment failure can be disastrous. If a clamp, chuck, or jig breaks or vacuum fails while a small part is being ground, the small part will often accelerate off the table, flying at high speed through a workshop. The part may be damaged, equipment in the workshop may be damaged, and the grinder operator and other individuals in the area may be injured.

Some devices employ magnets, either releasable electromagnets or permanent magnets such as ferrite or rare earth magnets, to hold small objects in place for welding, grinding or cutting. Examples of such devices are U.S. Pat. No. 7,009,480, and U.S. Pat. No. 8,217,743. Such devices, however, suffer from a variety of limitations.

Thus, there is a need for a compact, portable, simple system for securing small metal parts to a work table in such a manner that the part is unlikely to come loose from the table. It is advantageous if as large an area as possible of the part is exposed to grinding, and the part can be easily repositioned.

### SUMMARY OF THE INVENTION

The following summary of the present invention is not intended to describe each illustrated embodiment or every possible implementation of the invention, but rather to give illustrative examples of application of principles of the invention.

In some embodiments, the magnetic table includes a box having a liftable top attached to a bottom member, the bottom member having one or more magnets; and the top having one or more openings therethrough, the openings being positioned to receive the magnet(s).

The liftable top may be openable in, for example, a clamshell or bookwise manner. An opening handle may be provided for convenience. A variety of means for attaching the liftable top to the bottom member may be employed, including hinges, wire, plastic ties, clamps, and any other means of linking at least one side of the liftable top to one side of the bottom member.

A object, part, or workpiece may be placed atop the closed magnetic table, contacting or nearly contacting the exposed magnet(s). The object, part, or workpiece will then be held in place for grinding, welding, or other work. When the user wishes to free the workpiece, he or she may then open the top. The lever-like motion of this lifting action exerts a force sufficient to separate the workpiece(s) from even a very strong magnet. Once lifted away from the magnet, the workpiece(s) slides easily from the surface of the lifting top into a collection container, etc.

In some embodiments, the magnet may be ferromagnetic, electromagnetic, or a rare earth magnet. In accordance with one aspect of the present disclosure, the magnets may be shaped like bars, like upright fingers, or like rectangular segments, or any other shape suitable for magnetically engaging with a part to be ground or welded. The magnet(s) may be protected by a metallic holder or jacket which extends the magnetic attraction of the magnet beyond the actual dimensions of the magnet(s). In this manner, the magnet can be recessed into the jacket so that the magnet itself is less likely to be impacted by a part being ground or polished—causing damage to the magnet.

In some embodiments, the bottom member may include one or more adjustment members which allow for the adjustment of the relative distance between the bottom member and the liftable top, thereby controlling the extent to which the magnet(s) or jackets extend beyond the liftable top.

In one conformation, the holder or jacket may be, for example, a generally U-shaped segment of steel, adapted to contain the magnet and be generally open along the top and the two short sides. One advantage of this configuration is that the magnet may be easily inserted and recessed into the jacket and then be provided with a protective cover. The protective cover may be, for example, plastic, non-ferromagnetic metal such as aluminum, ceramics, or any substance known to one of skill in the art to provide an adequately protective cover over the magnet. The protective cover may be a film or may be applied in layers. It may cover the entire magnet, or merely be disposed on one side thereof. The thickness of the protective coating may be variable across the magnet, or may be shaped to tightly engage the holder or jacket to prevent the magnet from accidentally falling out of the holder.

In some embodiments, the liftable top of the magnetic table may comprise an industrial finish such as a ceramic finish or powder coating. It is generally advantageous if the industrial finish is non-ferromagnetic. The industrial finish may be high contrast, for example, white or brightly colored, so that a workpiece held magnetically thereon is easy to observe.

In accordance with one aspect of the present disclosure, the liftable top may have three or more openings configured to admit a number of magnets and magnet holders. In some embodiments, these openings may be surrounded by a gasket such as a rubber skirting or flange, adapted to admit a magnet. When the liftable top is closed, the magnet and magnet jacket pushes up through the opening and gasket. When the liftable top is opened, the gasket helps to sweep the magnet clean of accumulated dust or debris.

In some embodiments, the bottom member comprises mounting magnets positioned to affix the magnetic table to a metal surface. The mounting magnets may be, for example, circular, square, or stud-like. They may be recessed into the bottom member or may have jackets or guards surrounding the magnets with a lip to reduce the risk of the magnets being damaged by impact with a tool or surface. The mounting magnet lip or guard may be made from a material which propagates magnetism to thereby hold the magnetic table on a piece of steel or other similar metal.

In accordance with one aspect of the present disclosure, the bottom member may comprise a secondary handle. This secondary handle may be used for carrying the table. It could also be used to assist in moving the liftable top and the bottom member away from one another.

In accordance with another aspect of the disclosure, the invention may be practiced by forming a box having a liftable top and a bottom member; affixing jackets to the bottom member, affixing a means for vertical adjustment to the liftable top relative to the bottom member; affixing magnets to the holders; and forming openings in the liftable top to receive the magnets. In some embodiments, disk or mounting magnets may also be affixed to the bottom member, in order to removeably attach the magnetic frame to a ferromagnetic work space, such as a typical steel grinding table. If disk magnets are used, the magnets may be recessed, or have a raised lip or rim therearound, in order to prevent the magnets from scraping the table. In other embodiments, the magnetic table may be affixed to a table by means of, for example, clamps, screws, bolts, or any other means known to one of skill in the art, capable of stabilizing the frame.

One advantage of using magnetic means to attach the frame to the workspace is that the magnetic frame may be quickly and conveniently freed from the workspace by applying a twisting motion. If desired, the magnetic table could also be applied to non-horizontal surfaces and still hold the parts being ground or polished.

These and other aspects of the present invention are realized in a magnetic table as shown and described in the following figures and related description. It will be appreciated that various embodiments of the invention may not include each aspect set forth above and aspects discussed above shall not be read into the claims unless specifically described therein.

### BRIEF DESCRIPTION OF THE DRAWINGS

Various embodiments of the present disclosure are shown and described in reference to the numbered drawings.

FIG. 1 shows a perspective view of a magnetic table made in accordance with some aspects of the present disclosure in a closed, carrying position;

FIG. 2 illustrates a perspective view of the magnetic table of claim 1, in an open configuration;

FIG. 3 shows one embodiment of the bottom member of a magnetic table, with magnets affixed in the holding jackets;

FIG. 4 shows an end cross-sectional view of the liftable top portion, the magnet, an adjustment mechanism, and the bottom member; and

FIG. 5 illustrates a bottom view of magnetic table of FIG. 1.

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one configuration,” “one embodiment” “one aspect” or “a configuration,” “an embodiment” or “an aspect” means that a particular feature, structure, or characteristic described in connection with the configuration may be included in at least one configuration and not that any particular configuration is required to have a particular feature, structure or characteristic described herein. The appearances of the phrase “in one configuration” or similar phrases in various places in the specification are not necessarily all referring to the same configuration, and may not necessarily limit the inclusion of a particular element of the invention to a single configuration, rather the element may be included in other or all configurations discussed herein. Thus it will be appreciated that the claims are not intended to be limited by the representative configurations shown herein. Rather, the various representative configurations are simply provided to help one of ordinary skill in the art to practice the inventive concepts claimed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The invention and accompanying drawings will now be discussed in reference to the numerals provided therein so as to enable one skilled in the art to practice the present invention. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

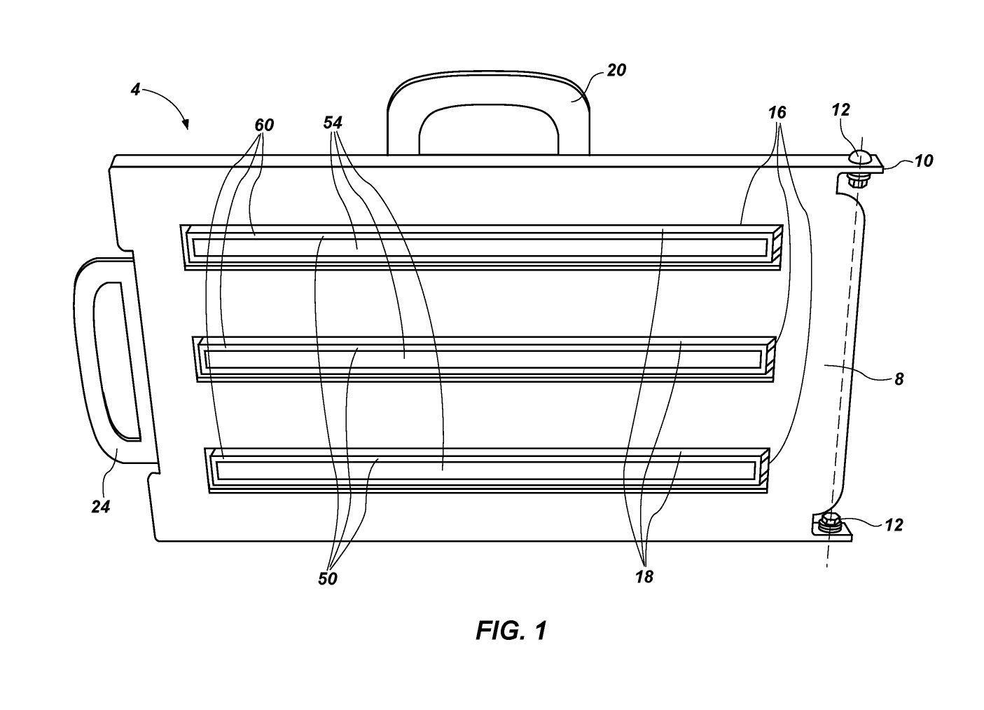

Turning now to FIG. 1, there is shown a perspective view of a magnetic table, generally indicated at 4. The magnetic table is disposed in a closed, carrying position as would be used for transporting the table 4 from location to location. The magnetic table 4 may include a liftable top 8 and a bottom member 10 which may be attached to the top 8 by one or more bolts or other fasteners to form a hinge (Indicated by dashed line 12) about which the top can pivot relative to the bottom member. As will be discussed in additional detail below, the hinge 12 allows the liftable top 8 to pivot away from the bottom member 10 and release materials magnetically held adjacent the top.

The liftable top 8 may be coated with an industrial finish such as ceramic or powder coating and the like. The liftable top 8 may be given a high-contrast color such as yellow to clearly identify the location of the magnets.

The task of lifting the liftable top 8 is made more mechanically efficient by an opening handle 24 which is disposed adjacent an end of the top generally opposite the hinge 12. It will be appreciated that the opening handle 24 may be, for example, a lever, a ridge, a grip shaped to fit a human hand, or any other means of obtaining good mechanical leverage to pivot the top 8 away from the bottom member 10 and thereby open the magnetic table.

The magnetic table 4 may also be equipped with a carrying handle 20. The handle 20 can be used to carrying the magnetic table 4 from location to location without causing the table to open. In the event that the magnetic table 4 is affixed to a work surface with mounting magnets (not visible), a user may also use the handle 20 (alone or in conjunction with handle 24) to provide torque to the table to help release the table from the surface on which it is mounted.

Also shown in FIG. 1 are several openings 16 formed in the liftable top 8.

These openings 16 may be, for example, long slots, round circles, square holes, or any other shape configured to permit a magnet assembly 50 to extend from a position below the top 4 to a position immediately adjacent or above the top. The magnet assembly 50 may include a magnet (not visible in FIG. 1) and magnet holder or jacket 60. The magnet disposed in the magnet assembly 50 may be, for example, a bar, a finger-shaped vertical projection, a square pillar, or any other shape suitable for fitting through the opening 16 in the liftable top 8 and for being held by the jacket 60. As shown in FIG. 1, the jackets 60 and the magnets (not shown) inside are elongate. Other shapes could be used. Additionally, FIG. 1 shows magnet assembles attached to the upper side of the bottom member. As will be discussed below, one or more magnet assemblies may be attached to the lower side of the bottom member.

The opening 16 and the magnet assembly 50 may leave a gap 18 therebetween. The gap 18 may be useful in allowing dust to be attracted to the sides of the magnet assembly 50 and away from the upper surface of the top 8 where it might interfere with grinding.

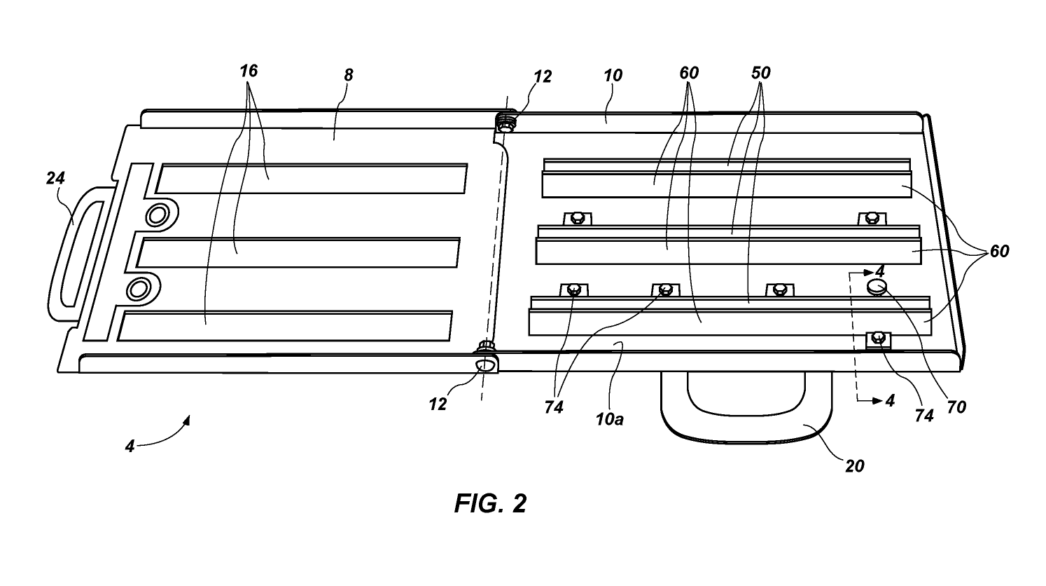

FIG. 2 illustrates a perspective view of the magnetic table, generally indicated at 4, in an open position so that the underside of the top 8 is exposed on the left, and the bottom member 10 is exposed on the right. In this embodiment, the top 8 is attached with nuts and bolts which form a hinge 12 for pivoting with the bottom member 10. In the present embodiment, the magnetic table 4 is generally rectangular and box-shaped, however other configurations such as circular, square, and irregular shapes are possible. The bottom member 10 may be, for example, a tray, a frame, a grid, or other shape sufficient to keep the magnet assemblies 50 aligned with openings 16.

The top 8 as shown in provided with three opening 16, though other numbers of openings may be used. The openings 16 may be sized, shaped, and placed to allow the magnet assemblies 50 (and primarily the jackets 60), which are affixed to the bottom member 10, to extend at least to be at the same height as the top surface of the top 8, and commonly to extend about ⅙^{th} to ¼^{th} inch above the top surface of the top 4 when the top is in the closed position.

The bottom member 10 may include the handle 20 and a mechanism 70 (such as an adjustable bolt) for adjusting the height of the table top 4 relative to the bottom member and magnet assemblies 50 when the top is closed. The bottom member 10 may be substantially flat or shallowly cupped, or it may be deeply cupped to permit excess dust to collect between the holders 60 for easy disposal.

The magnet assemblies 50 may be secured to the floor 10a of the bottom member by a variety of mechanisms including welding, attachment via bolts 74, adhesives, etc. The bolts 74 may also be used to secure the handle 20 in place.

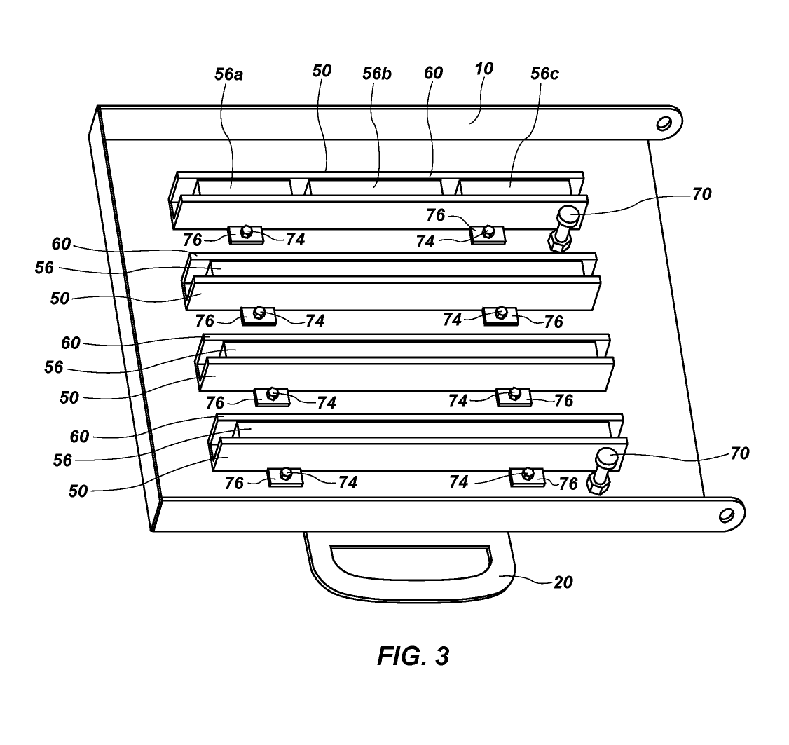

FIG. 3 shows one embodiment of the bottom member 10, with four magnet assemblies 50 attached via bolts 74 and brackets 76 to the floor 10a of the bottom member. The magnet assemblys 50 may include one or more magnets 56 disposed in each of the jackets 60. Not only can the magnets attract and hold a device, the magnetic coupling passes through the jackets 60 so that the magnets 56 can be recessed to prevent them from getting damaged. In FIG. 3 the protective cover (see 55 in FIG. 1) has been omitted to expose the magnets.

FIG. 3 further shows that different numbers of magnet assemblies 50 may be used. A top used with the bottom member 10 of FIG. 3 would likely have 4 openings therein. Additionally, FIG. 3 shows adjustable bolts 70 for adjusting the height of the top relative to the bottom member.

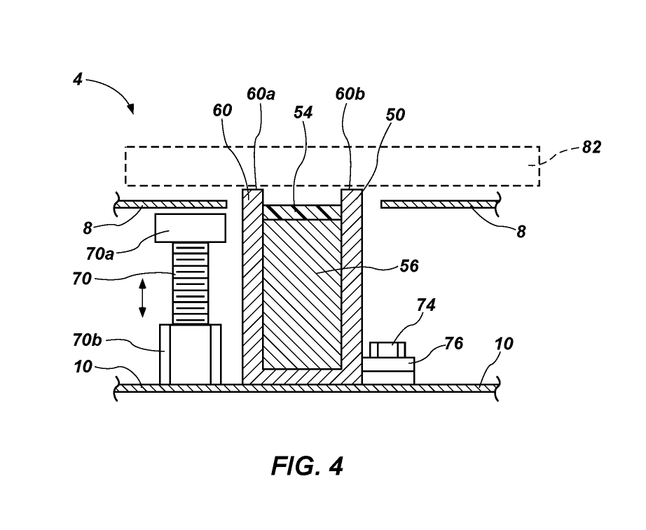

Turning now to FIG. 4, there is shown a close-up, fragmented cross-sectional view of a closed table 4 taken through one of the magnet assemblies 50. The magnet assembly 50 may include a jacket 60 which holds a magnet 56. This embodiment may also include a protective cover 54, such as plastic, rubber, non-ferromagnetic metal, or the like to prevent damage to the magnet. The magnet assembly 50 may be secured to the floor of the bottom member 10 by a bracket 76 and bolt 74.

The jacket 60 is typically made from a magnetically conductive material, such as steel, so that the magnetism of the magnet is propagated. This allows the upper ends 60a, 60b of the jacket, which may extend beyond the top 8, to receive and magnetically hold a piece of metal (shown as dashed line 82) for polishing, grinding, etc. The extent to which the upper ends 60a and 60b extend above the top 8 can be controlled by adjusting the adjustment mechanism 70, which may be formed by a bolt 70a and a nut 70b.

When the user is through working with the table 4, the piece of metal 82 being worked by the user can be removed by simply lifting the top 8, such as by lifting up on the handle 24 (FIG. 1), to thereby pull the metal away from the magnetic assembly 50. If a container is disposed adjacent the table, the piece of metal 82 can be made to slide into the container. It will be appreciated that, depending on the size of the magnetic table 4, a number of pieces may be ground, polished, etc. one after the other and then all of the pieces released at substantially the same time by lifting the top 8 with the handle 24.

In some embodiments, the magnet 56 is immoveably fixed to the jacket 60 by means such as adhesive, bolts, sauter, a strip of ferromagnetic material affixed to the bottom of the jacket 60, or other means known to one of skill in the art. In other embodiments, the magnet 56 can be released from the magnet jacket 60 by, as in this embodiment, sliding the magnet 56 sideways out of the jacket. Moreover, it will be appreciated that while a single magnet is shown in a given jacket 60, a plurality of magnets, such as 56a, 56b and 56c can be used as shown in FIG. 3.

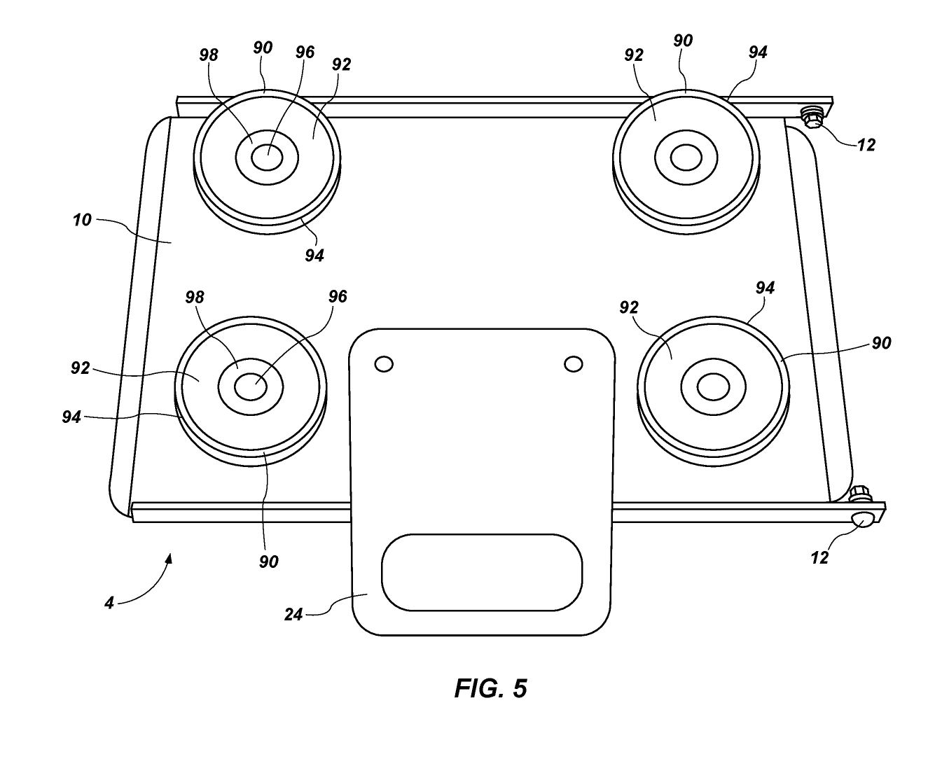

FIG. 5 shows a perspective view of the bottom of the bottom member 10 of the table 4. The bottom member 10 is equipped with means for securely attaching the magnetic table 4 to a work location. In this case, a plurality of magnet assemblies 90 are attached to the floor 10a of the bottom member 10. The magnet assemblies 90 may include a magnet 92, a jacket or lip 94 for covering sides of the magnets 92 and a fastener 96 for attaching the magnet assemblies 90 to the floor 10a of the bottom member 10. The jackets 94 may be taller than the thickness of the magnets 92 so that the jackets extend beyond the magnets 90. The jackets 94 may be made of a material capable of propagating magnetism so that the jackets 94 are actually what contact a work surface (such as the top of a steel work bench) to hold the magnetic table in place.

The magnets 92 shown in FIG. 5 are circular magnets with a center void 98 for receiving the fastener 96. It will be appreciated, however, that a variety of magnet configurations can be used. In the embodiment shown in FIG. 5, the jackets 90 could be cylindrical or cup shaped and have a hole through which the fastener can pass to hold the magnet assembly to the bottom member 10.

The magnet assemblies 90 allow the magnetic table 4 to be attached to a work surface regardless of whether the work surface is horizontal. For example, in some applications a person may wish for the table 4 to be held at a 45 degree angle. If a steel beam is disposed at the desired angle, the table 4 can be magnetically attached thereto and the table used as desired.

In order to separate the magnetic table 4 from a metal work table, a user can simply grip the handle 20 and opening handle (24, not shown) and twist. In other embodiments, the disk magnets 90 may be replaced with or used in conjunction with, for example, clamps, vices, adhesive pads, variously shaped magnets, or other means known to one of skill in the art for attaching a magnetic frame 4 to a work surface. However, the magnetic assemblies 90 are presently preferred.

Thus there is disclosed a magnetic table system and methods of using the same. It will be appreciated that numerous modifications may be made without departing from the scope and spirit of this disclosure. The appended claims are intended to cover such modifications.

What is claimed is:

1. A magnetic table comprising:
a top having at least one opening therein; and
at least one magnet assembly extending through the top.

2. The magnetic table of claim 1, further comprising a bottom member, and the top being pivotably attached to the bottom member.

3. The magnetic table of claim 2, wherein the at least one magnet assembly is attached to the bottom member.

4. The magnetic table of claim 1, wherein the at least one magnet assembly comprises a jacket and at least one magnet disposed inside the jacket.

5. The magnetic table of claim 4, wherein the at least one magnet assembly comprises at least one protective cover disposed over the at least one magnet.

6. The magnetic table of claim 5, wherein the jacket has an open top and wherein the protective coating is disposed on top of the magnet.

8. The magnetic table of claim 2, wherein the bottom member further comprises AN adjustment mechanism for adjusting a relative distance between the top and the bottom member.

9. The magnetic table of claim 8, wherein the adjustment mechanism comprises a bolt and a nut.

10. The magnetic table of claim 2, wherein the bottom member has an upper surface and a lower surface, and wherein the bottom member as has at least one magnetic assembly attached to the upper surface and at least one magnetic assembly attached to the lower surface.

11. The magnetic tale of claim 10, wherein the at least one magnetic assembly attached to the upper surface comprises an elongate jacket having a bar shaped magnet disposed therein and wherein the at least one magnetic assembly attached to the lower surface comprises a cylindrical jacket and a generally circular magnet.

12. The magnetic table of claim 1, wherein the top has at least two openings formed therein and wherein a magnet assembly is disposable in each opening by moving the top into a closed position.

13. The magnetic table of claim 2, wherein the bottom member further comprises disk magnets.

14. A magnetic table comprising:
A box comprising a liftable top attached to a bottom member, the bottom member having two or more magnet assemblies, each magnet assembly having a jacket and a magnet; and
the liftable top having two or more openings therethrough, the openings being positioned to receive the magnet assemblies of the bottom member.

15. The magnetic table of claim 14 further comprising a lifting handle positioned to facilitate moving the liftable top away from the bottom member.

16. The magnetic table of claim 14, further comprising a plurality of magnetic assemblies attached to a side of the lower member oppose the two or more magnet assemblies for holding the lower member to a metallic working surface.

17. A magnetic table, the magnetic table comprising a top having a plurality of openings therein, a bottom pivotably attached to the top, a plurality of magnets attached to the bottom member, the magnets being in alignment with the openings in the top.

18. The magnetic table of claim 17, wherein the bottom member has a upper surface and a lower surface and wherein at least one of the plurality of magnets is attached to the upper surface and at least one of the plurality of magnets attached to the lower surface.

19. A method of forming a magnetic table comprising the steps of:
forming a box having a liftable top and a bottom member;
affixing holders having a means for vertical adjustment to the bottom member;
affixing magnets to the holders; and
forming openings in the liftable top to receive the magnets.
